(19) United States
(12) Patent Application Publication
(10) Pub. No.: US 2026/0365081 A1
(43) Pub. Date: Nov. 19, 2026

(54) SYSTEM AND METHOD CONTINUOUS COOLING FOR IMMERSED BATTERY

(71) Applicant: Ford Global Technologies, LLC, Dearborn, MI (US)

(72) Inventors: Mihir Devendra Upadhye, Livonia, MI (US); Kevin Mackenzie, Canton, MI (US); Nathan Lee, Novi, MI (US); Kevin Higgins, Waterford, MI (US)

(21) Appl. No.: 19/208,424

(22) Filed: May 14, 2025

(51) Int. Cl. B60L 58/26; B60L 50/64; H01M 10/42; H01M 10/613; H01M 10/625; H01M 10/633; H01M 10/6568; H01M 50/249

(52) U.S. Cl. CPC B60L 58/26; B60L 50/64; H01M 10/425; H01M 10/613; H01M 10/625; H01M 10/633; H01M 10/6568; H01M 50/249; B60L 2210/10; H01M 2220/20

(57) ABSTRACT

Systems and methods controlling operation of a traction battery pack of a vehicle described. The system and methods may allow a battery pack that is split into two or more groups of battery cells to be controlled to a desired temperature and remain operational in the presence of battery pack degradation.

### FIELD

The present description relates to methods and a system for cooling an immersed battery pack that is comprised of a plurality of battery cell groups.

### BACKGROUND

A traction battery may include battery cells that are immersed in a fluid. The fluid may extract heat from the traction battery and/or it may transfer heat to the battery cells. The fluid may flow from the traction battery to a heat exchanger where the heat is released to ambient air. Alternatively, heat may be transferred to the traction battery via a heat source that heats the fluid that is circulated within the traction battery. The traction battery may also provide electric power to a pump that provides motive force to transfer the fluid within a traction battery heat transfer system.

### BRIEF DESCRIPTION OF THE DRAWINGS

The advantages described herein will be more fully understood by reading an example of an embodiment, referred to herein as the Detailed Description, when taken alone or with reference to the drawings, where:

FIG. 1 is a schematic view of an example electric vehicle;

FIGS. 2-5 show example traction battery electric and cooling systems;

FIG. 6 shows a flowchart of a method for controlling a traction battery; and

FIG. 7 shows an example traction battery operating sequence.

### DETAILED DESCRIPTION

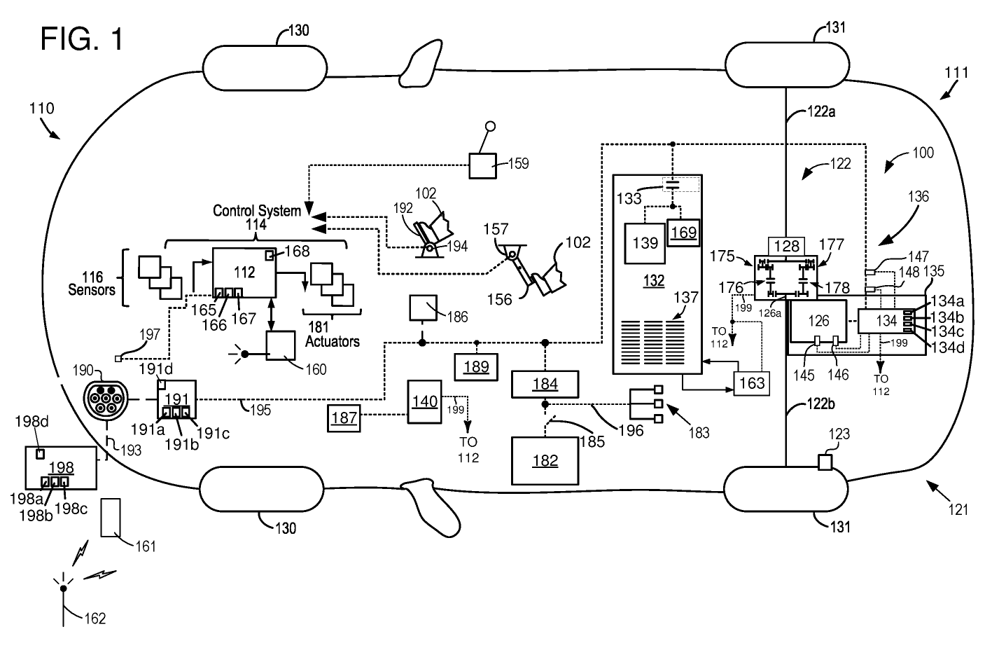

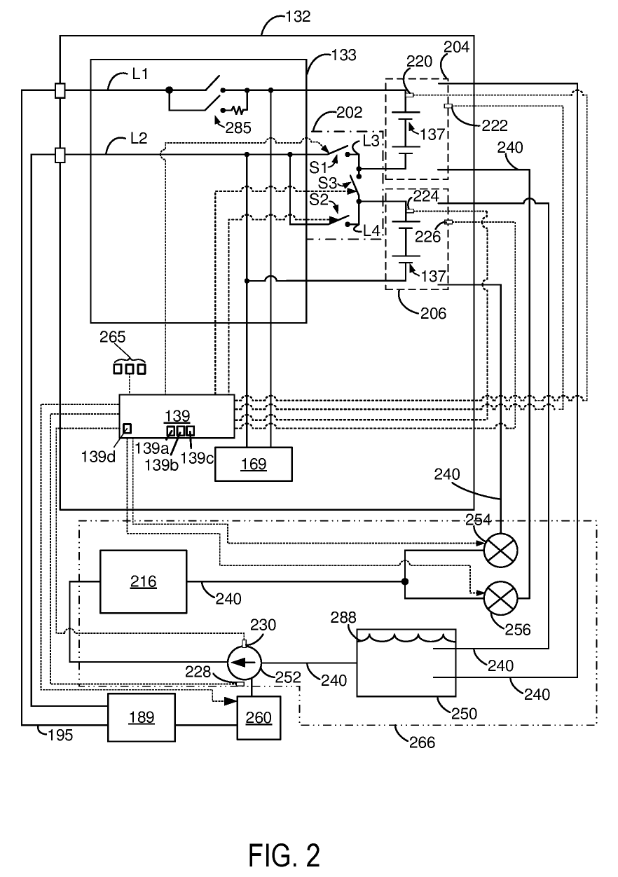

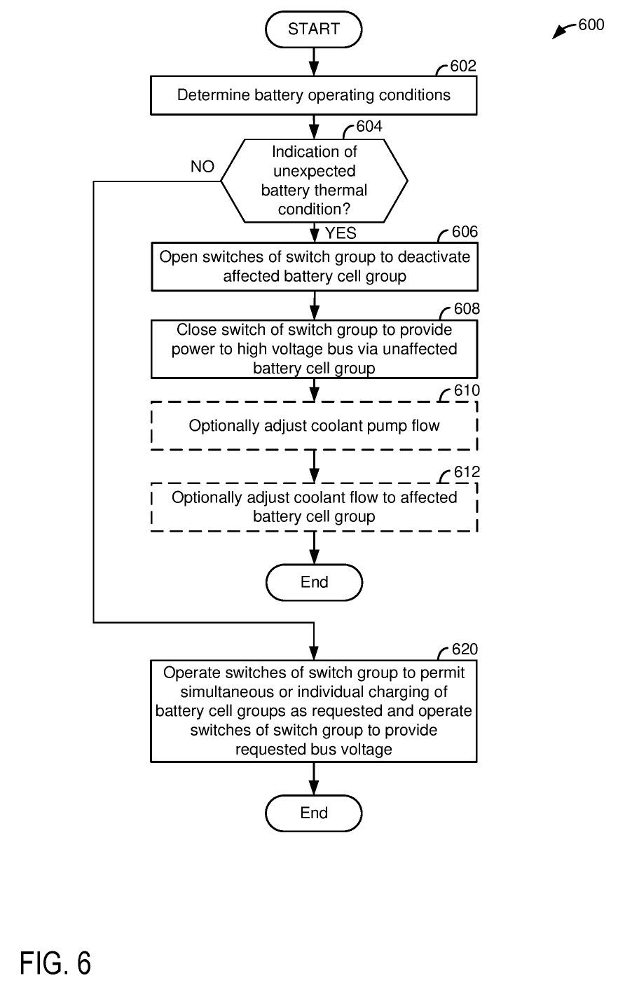

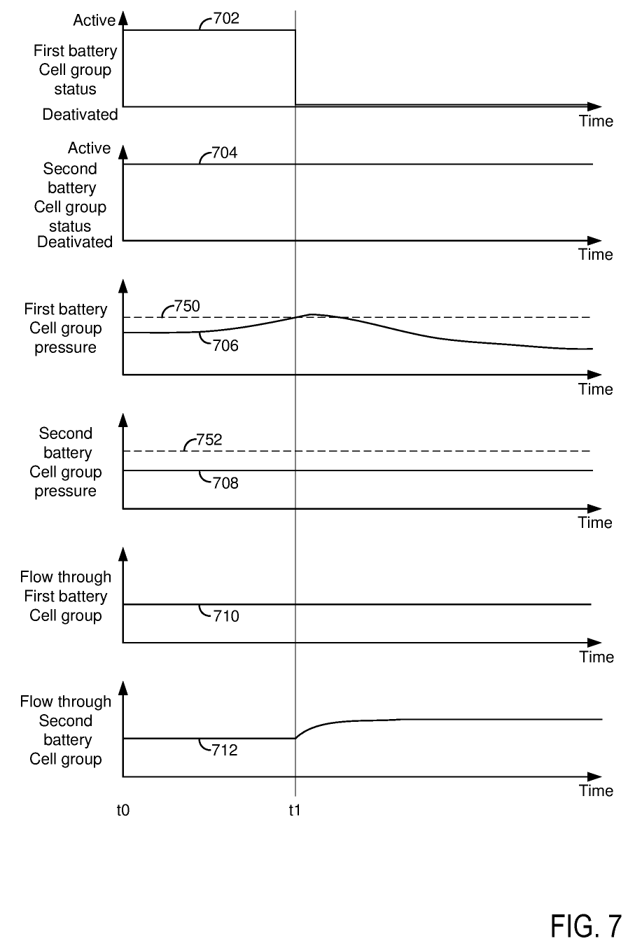

The present description is related to cooling and operating a battery pack that is comprised of a plurality of battery cells. The battery pack may be monitored for evidence of thermal degradation. If thermal degradation is detected, degraded battery cells may be electrically activated or deactivated from via one or more switches. Additionally, flow of cooling fluid within the battery pack may be adjusted based on indications of thermal degradation to reduce temperature increases within the battery pack. The battery pack may be included in an electric vehicle as shown in FIG. 1. The battery pack may be configured and operate as shown in FIGS. 2-5. A method for operating a battery pack is shown in FIG. 6 and an example battery pack operating sequence is shown in FIG. 7.

Some battery cells of a battery pack may experience thermal degradation at some time during a life cycle of the battery pack. Thermal degradation may reduce output capacity of a battery pack that forms a traction battery (e.g., a battery that provides motive force to propel a vehicle). Therefore, it may be desirable to electrically deactivate the degraded battery cells from the battery pack by preventing electric current flow to or from a degraded battery cell group. However, if the battery pack is cooled via fluid, deactivating the degraded battery cells from the battery pack may cease battery pack cooling. The cessation in battery pack cooling may not be desirable since it may be more difficult to extract heat from within the battery cell. Therefore, it may be desirable to provide a way of maintaining battery pack cooling in the presence of degraded battery cells.

The inventors herein have recognized the above-mentioned issue and has developed a method for controlling a battery pack, comprising: via one or more controllers, electrically deactivating a first group of fluid immersed battery cells of the battery pack and electrically activing a second group of fluid immersed battery cells of the battery pack in response to an indication of thermal degradation of the first group of fluid immersed battery cells.

By deactivating a first group of fluid immersed battery cells of a battery pack from a vehicle’s high voltage bus and activating a second group of fluid immersed battery cells, it may be possible to provide electric power to a coolant pump that supplies a fluid to cool the battery pack. Consequently, temperatures within the battery pack may be maintained closer to desired temperatures. Further, the battery pack may also be able to supply some power for propulsive effort.

The present description may provide several advantages. In particular, the approach may provide protection for battery cells and battery load consumers. Further, the approach may provide power for cooling a battery even during conditions when battery cell degradation occurs. Additionally, the approach may provide electric power for vehicle propulsion even when battery cell degradation occurs.

The above advantages and other advantages, and features of the present description will be readily apparent from the following Detailed Description when taken alone or in connection with the accompanying drawings.

It may be understood that the summary above is provided to introduce in simplified form a selection of concepts that are further described in the detailed description. It is not meant to identify key features of the claimed subject matter, the scope of which is defined uniquely by the claims that follow the detailed description. Furthermore, the claimed subject matter is not limited to implementations that solve any disadvantages noted above or in any part of this disclosure.

FIG. 1 is a block diagram of an example vehicle propulsion system 100 for vehicle 121. A front portion of vehicle 121 is indicated at 110 and a rear portion of vehicle 121 is indicated at 111. Vehicle propulsion system 100 includes electric machine 126. Electric machine 126 may consume or generate electrical power depending on its operating mode. Throughout FIG. 1, mechanical connections between various components are illustrated as solid lines, whereas electrical connections between various components are illustrated as dashed lines.

Vehicle propulsion system 100 includes a rear axle 122. In some examples, rear axle 122 may comprise two half shafts, for example first half shaft 122a, and second half shaft 122b. Vehicle propulsion system 100 further has front wheels 130 and rear wheels 131. Rear wheels 131 may be driven via electric machine 126.

The rear axle 122 is coupled to electric machine 126. Rear drive unit 136 may transfer power from electric machine 126 to axle 122 resulting in rotation of rear wheels 131. Rear drive unit 136 may include a low gear 175 and a high gear 177 that are coupled to electric machine 126 via output shaft 126a of electric machine 126. Low gear 175 may be engaged via fully closing low gear clutch 176. High gear 177 may be engaged via fully closing high gear clutch 178. High gear clutch 178 and low gear clutch 176 may be opened and closed via commands received by rear drive unit 136 over controller area network (CAN) 199. Alternatively, high gear clutch 178 and low gear clutch 176 may be opened and closed via digital outputs or pulse widths provided via control system 114. Rear drive unit 136 may include differential gears 128 so that torque may be provided to first half shaft 122a and to second half shaft 122b. In some examples, an electrically controlled differential clutch (not shown) may be included in rear drive unit 136.

Electric machine 126 may receive electrical power from onboard electrical energy storage device (e.g. a traction battery or battery pack) 132. Furthermore, electric machine 126 may provide a generator function to convert the vehicle’s kinetic energy into electrical energy, where the electrical energy may be stored at electric energy storage device 132 for later use by electric machine 126. An inverter system controller 134 (ISC1) may convert alternating current generated by electric machine 126 to direct current for storage at the electric energy storage device 132 and vice versa. Electric drive system 135 includes electric machine 126 and inverter system controller 134. Electric energy storage device 132 may be a battery, capacitor, inductor, or other electric energy storage device. Electric power flowing into electric drive system 135 may be monitored via current sensor 145 and voltage sensor 146. Position and speed of electric machine 126 may be monitored via position sensor 147. Torque generated by electric machine 126 may be monitored via torque sensor 148.

Electric machine 126 may propel vehicle 121 in a forward direction or reverse direction in response a position of shift selector 159. Further, vehicle 121 may enter park (e.g., no vehicle movement with vehicle wheels locked) or neutral in response to a position of shift selector 159.

In some examples, electric energy storage device 132 may be configured to store electrical energy that may be supplied via a high voltage bus 195 (e.g., components such as conductors that carry electric current and high voltage (e.g., voltage greater than 60 volts)). High voltage bus 195 may be in electrical communication with high voltage vehicle accessories (e.g., heat pump, air conditioner, heater, etc.) 186 and power converter 191 (e.g., direct current (DC) to DC converter or alternating current (AC) to DC converter). Power converter 191 is electrically coupled to electrical receptacle 190 and electrical receptacle 190 may be electrically coupled to an external charging station 198 (e.g., a direct current fast charger (DCFC), level 2 charger (e.g., a 240 volt alternating current charger), or a level 1 charger (e.g., 120 volt alternating current charger)) via cord 193. External charging station 198 includes non-transitory (e.g., read exclusive memory) 198a, random access memory 198b, digital inputs/outputs 198c, and a microcontroller 198d. Power converter 191 may control electric current flow and voltage supplied to electric energy storage device 132. Power converter 191 may include a non-transitory (e.g., read exclusive memory) 191a, random access memory 191b, digital inputs/outputs 191c, and a microcontroller 191d. Receptacle sensor 197 provides an indication of whether or not vehicle 121 is plugged in to the external charging station 198. External charging station 198 resides external to the vehicle (e.g., not part of the vehicle). High voltage bus 195 may also be electrically coupled to a DC/DC converter 184, which allows electric power to be transferred from high voltage bus 195 to low voltage bus 196 (e.g., conductors, terminals, and other conductive linking devices), and DC/DC converter 189 for operating higher power DC devices. Thus, electric power may be exchanged between electric energy storage device 132 and low voltage battery 182 (e.g., battery voltage of less than 20 volts). Low voltage battery switch 185 may be selectively opened to prevent power to low voltage battery 182 (e.g., 12 volts DC) from low voltage bus 196. Low voltage bus 196 may distribute low voltage electric power to low voltage electric loads 183 (e.g., electric power consumers such as infotainment system, windshield wipers, blowers, etc.).

Returning to FIG. 1, electric energy storage device 132 includes a plurality of battery cells 137, an electric energy storage device controller 139, and a contactor module 133. Electric energy storage device controller 139 may provide charge balancing between energy storage element (e.g., battery cells) and communication with other vehicle controllers (e.g., controller 112). Contactor module 133, which may include one or more electrical contactors, controls flow of power into and out of electric energy storage device 132. Contactor module 133 may selectively couple and decouple electric energy storage device 132 to high voltage bus 195 and inverter system controller (ISC1) 134. In some examples, contactor module 133 may be located external to the electric energy storage device 132. Power distribution module 138 is also shown directly electrically coupled to protected DC/DC power supply 169.

Electric energy storage device temperature control system 163 (e.g., a heat pump or heat exchanger) may be configured as shown in more detail in FIG. 2. Alternatively, electric energy storage device temperature control system 163 may be more sophisticated and it may be configured as a heat pump so as to heat and/or cool electric energy storage device 132. Electric energy storage device temperature control system 163 may receive a requested electric energy storage device temperature via a controller that is coupled to CAN 199.

Control system 114 may communicate with electric machine 126, energy storage device 132, navigation system 187, etc. Control system 114 may receive sensory feedback information from electric drive system 135 and electric energy storage device 132, etc. Further, control system 114 may send control signals to electric drive system 135 and electric energy storage device 132, etc., responsive to this sensory feedback. Control system 114 may receive an indication of an operator requested output of the vehicle propulsion system from a human operator 102, or an autonomous controller. For example, control system 114 may receive sensory feedback from pedal position sensor 194 which communicates with pedal 192. Pedal 192 may refer schematically to a driver demand pedal. Similarly, control system 114 may receive an indication of an operator (e.g., user) requested vehicle slowing via a human operator 102, or an autonomous controller. For example, control system 114 may receive sensory feedback from pedal position sensor 157 which communicates with vehicle caliper control pedal 156.

One or more wheel speed sensors (WSS) 123 may be coupled to one or more wheels of vehicle propulsion system 100. The wheel speed sensors may detect rotational speed of each wheel. Such an example of a WSS may include a permanent magnet type of sensor.

Controller 112 may comprise a portion of a control system 114. In some examples, controller 112 may be a single controller of the vehicle. Control system 114 is shown receiving information from a plurality of sensors 116 (various examples of which are described herein) and sending control signals to a plurality of actuators 181 (various examples of which are described herein). As one example, sensors 116 may include tire pressure sensor(s) (not shown), wheel speed sensor(s) 123, etc. In some examples, sensors associated with electric machine 126, wheel speed sensor 123, etc., may communicate information to controller 112, regarding various states of electric machine operation. Controller 112 includes non-transitory (e.g., read exclusive memory) 165, random access memory 166, digital inputs/outputs 168, and a microcontroller 167. Controller 112 may receive input data and provide data to human/machine interface 140 via CAN 199. Additionally, controller 112 may send vehicle data and receive command instructions (e.g. a request to prepare the vehicle for extended storage) via transceiver 160 and remote device 161 (e.g., cell phone, tablet, or other remote wireless device). Remote device 161 may transmit commands and receive data via cellular or satellite network 162.

Referring now to FIG. 2, it shows a schematic view of an example traction battery with its electric and cooling systems. In FIG. 2, electrical conductors and mechanical components are shown with solid lines. Control signals or lines are shown as dashed lines. FIG. 2 is a detailed view of electric energy storage device 132 that is shown in FIG. 1. It may be appreciated that the traction battery shown in FIG. 2 is merely one example battery pack configuration that may benefit from the approach that is described herein.

Electric energy storage device 132 includes a contactor module 133 that includes one or more contacts (e.g., 285). Contactor module 133 controls connection of battery cells 137 with high voltage bus 195. Additionally, contactor module 133 may selectively connect battery cells 137 with other vehicle electric power consumers. Contactor module 133 may also provide interconnections between different devices that are included in electric energy storage device 132. For example, contactor module 133 is shown providing an electric power connection path or conductor between switch one (S1) and DC/DC converter 189. Likewise, contactor module 133 is shown providing an electric power connection path or conductor between switch two (S2) and DC/DC converter 189.

Switch module 202 or switch group includes three switches, switch one (S1), switch two (S2), and switch three (S3). Additionally, switch one, switch two, and switch three are electrically coupled together. Switch one is directly electrically coupled to conductor L2 and conductor L3. Switch two is directly electrically coupled to conductor L2 and conductor L4. Switch three is directly electrically coupled to conductors L3 and L4. Electrical conductor L1 is electrically coupled to DC bus 195 and contacts 285. Contacts 285 are electrically coupled to the battery cells 137 having the highest voltage within the electric energy storage device 132.

Electric energy storage device 132 includes a first group 204 of battery cells 137 and a second group 206 of battery cells 137. First group 204 of battery cells 137 is directly electrically coupled to contacts 285 and conductor L3. Second group 206 of battery cells 137 is directly electrically coupled to conductor L4, conductor L2, and protected DC/DC power supply 169. Voltage of first group 204 may be determined via sensor 220 and pressure of fluid 288 circulating through first group 204 of battery cells 137 may be determined by sensor 222. Voltage of second group 206 may be determined via sensor 224 and pressure of fluid 288 circulating through second group 206 of battery cells 137 may be determined by sensor 226. Fluid 288 may be a coolant (e.g., glycol) that is circulated through battery cooling system 266 via pump 252 and conduits 240. Battery cooling system 266 may also include a heat exchanger 216, coolant flow control valves 254-256, and a coolant reservoir 250. Rotational speed of pump 252 may be determined via speed sensor 230 and electric input power to pump 252 may be determined via current sensor 228.

In this example, pump 252 is a variable speed pump that is powered via DC/DC converter 189 and inverter 260. Inverter 260 may supply alternating current (AC) at varying voltage and frequency to pump 252, thereby providing speed control of pump 252 to control coolant flow through battery cooling system 266. Additionally, a position of control valve 254 may be adjusted to control coolant flow through the second group 206 of battery cells 137. Further, a position of control valve 256 may be adjusted to control coolant flow through the first group 204 of battery cells 137.

Electric energy storage device controller 139 may control switches in switch module 202, a speed of pump 252, and positions of valves 254-256 according to output of sensors 220-230 and sensors 265. Sensors 265 may include but are not limited to battery temperatures, battery cell temperatures, battery currents, battery voltages, etc. For example, in response to an increase in pressure of fluid in first group 204, which may be indicative of an unexpected temperature increase within the first group 204, electric energy storage device controller 139 may command switches S1 and S3 open while switch S2 is commanded closed. This allows electric current flow into or out of first group 204 of battery cells 137 to be reduced to zero. Further, electric current flow is permitted from second group 206 of battery cells 137 to DC/DC converter 189, inverter 260, and pump 252. Thus, operation of electric energy storage device 132 and battery cooling system 266 may be preserved even in the presence of battery cell degradation. Electric energy storage device controller 139 includes non-transitory (e.g., read exclusive memory) 139a, random access memory 139b, digital inputs/outputs 139c, and a microcontroller 139d.

The system of FIGS. 1 and 2 provides for a battery pack system, comprising: a traction battery including a first group of battery cells immersed in a fluid and a second group of battery cells immersed in the fluid; and one or more controllers including executable instructions stored in controller memory that cause the one or more controllers to electrically deactivate the first group of battery cells or the second group of battery cells from a high voltage bus while electrically activating the other of the first group of battery cells or the second group of battery cells to the high voltage bus. In a first example, the battery pack system includes where the high voltage bus is electrically coupled to a traction motor. In a second example that may include the first example, the battery pack system includes where the high voltage bus is electrically coupled to a DC/DC converter, and where the DC/DC converter is electrically coupled to a pump. In a third example that may include one or both of the first and second examples, the battery pack system further comprises a battery cooling system including a heat exchanger, a pump, and one or more valves, the battery cooling system fluidically coupled to the traction battery. In a fourth example that may include one or more of the first through third examples, the battery pack system further comprises additional executable instructions that cause the one or more controllers to control flow of the fluid to the first group of battery cells immersed in the fluid and the second group of battery cells immersed in the fluid. In a fifth example that may include one or more of the first through fourth examples, the battery pack system includes where flow of the fluid is controlled via adjusting a rotational speed of the pump. In a sixth example that may include one or more of the first through fifth examples, the battery pack system includes where flow of the fluid is controlled via adjusting positions of the one or more valves. In a seventh example that may include one or more of the first through sixth examples, the battery pack system further comprises a switching module and where the first group of battery cells or the second group of battery cells is electrically isolated via the switching module.

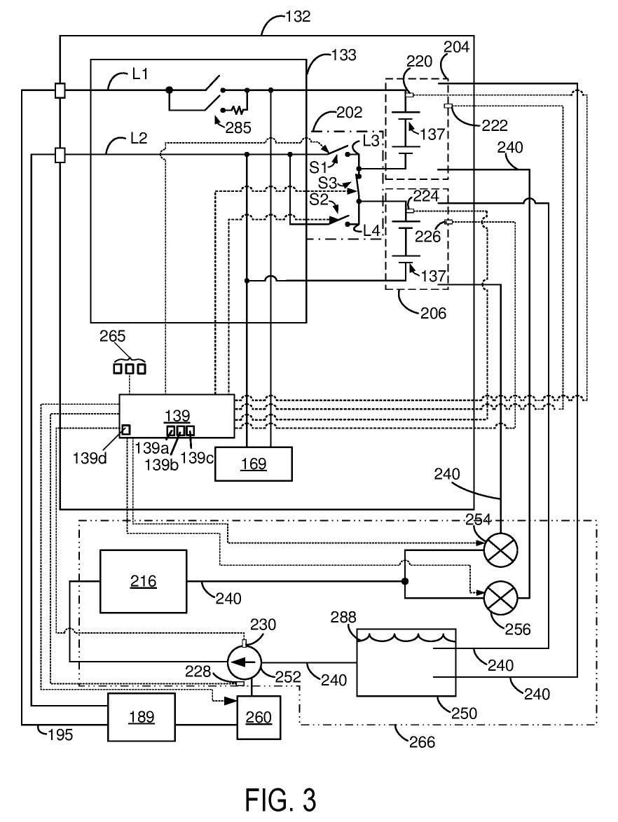

Referring now to FIG. 3, it shows a schematic view of a baseline configuration for the traction battery shown in FIG. 2. Each component that is shown in FIG. 2 is also shown in FIG. 3 and the components of FIG. 3 operate as is described in the description of FIG. 2. However, in FIG. 3, switch S3 is shown in a closed state (e.g., able to conduct electric current) while switches S1 and S2 are in open states (e.g., unable to conduct electric current). This allows the first group 204 of battery cells 137 to be arranged in series with the second group 206 of battery cells 137. In addition, this arrangement allows for charging or discharging of each battery cell in both groups of battery cells at a same time via the DC bus. Further, the voltage available at the DC bus is equal to the series voltage across the first group 204 and the second group 206 of battery cells 137. Accordingly, DC/DC converter 189, inverter 260, and pump 252 remain operational in this configuration and supplied with a high voltage level. Thus, closing S3 and opening S1 and S2 activates the first group 204 and the second group 206 of battery cells 137 by allowing these groups of battery cells to receive charge from the vehicle’s DC bus or supply charge to the vehicle’s DC bus.

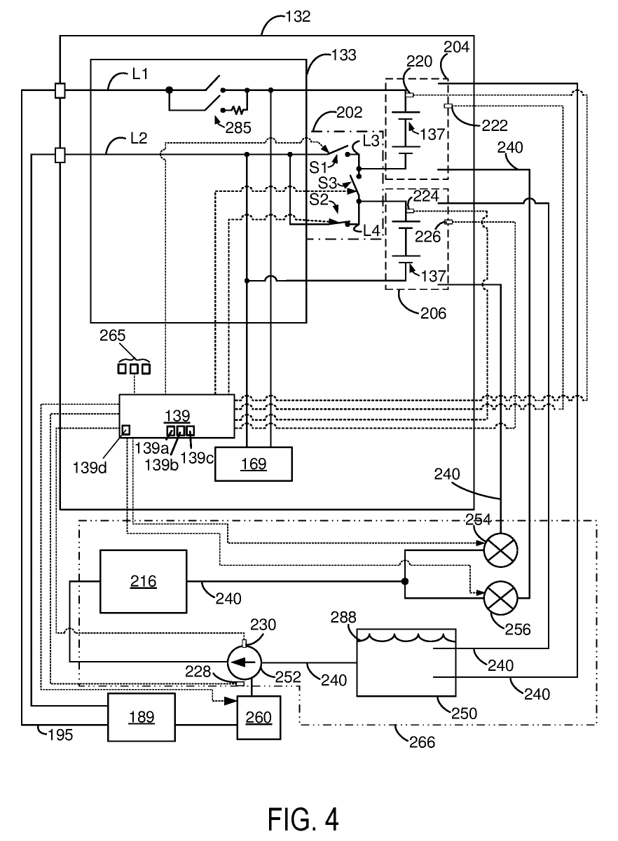

Referring now to FIG. 4, it shows a schematic view of a configuration that is based on degradation being detected within the first group 204 of battery cells 137 for the traction battery shown in FIG. 2. Each component that is shown in FIG. 2 is also shown in FIG. 4 and the components of FIG. 4 operate as is described in the description of FIG. 2. However, in FIG. 4, switch S2 is shown in a closed state while switches S1 and S3 are in an open state. This configuration suspends or prevents electric current flow through the first group 204 of battery cells 137 while still allowing electric current flow through the second group 206 of battery cells 137. Additionally, this arrangement causes the voltage that may be available at the DC bus to follow the voltage that is across the second group 206 of battery cells 137. Thus, the DC bus voltage may be reduced by one half if degradation of the first group 204 of battery cells 137 is detected. The DC bus voltage may be made available to electric machine 126 (e.g., a traction motor that provides propulsive effort for the vehicle), DC/DC converter 189, inverter 260, and pump 252. Accordingly, DC/DC converter 189, inverter 260, and pump 252 remain operational in this configuration when degradation is sensed within the first group 204 of battery cells. Thus, closing S2 and opening S1 and S3 activates the second group 206 and deactivates the first group 204 of battery cells 137 by allowing the second group 206 of battery cells to receive charge from the vehicle’s DC bus or supply charge to the vehicle’s DC bus. The first group 204 of battery cells 137 is deactivated since the first group 204 of battery cells 137 is not permitted to receive charge from or provide charge to the vehicle’s DC bus.

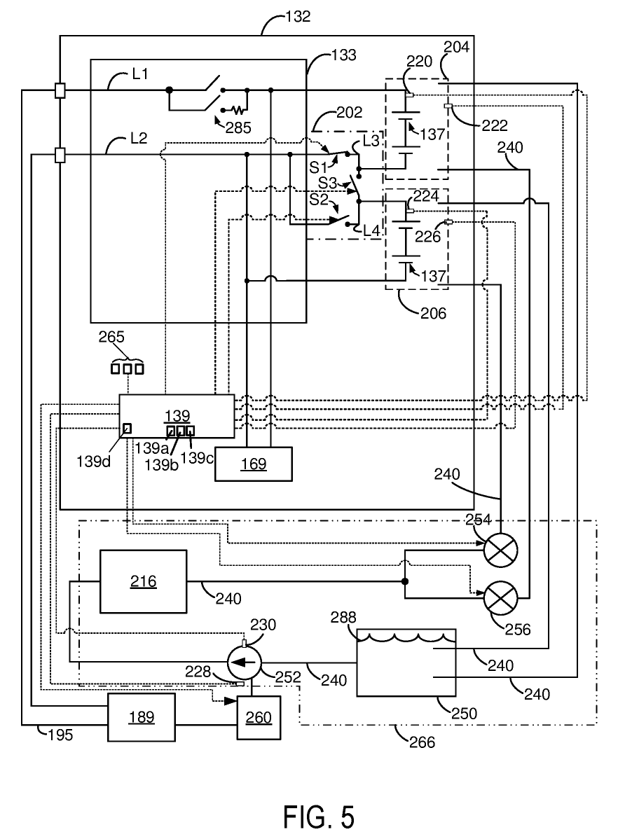

Referring now to FIG. 5, it shows a schematic view of a configuration that is based on degradation being detected within the second group 206 of battery cells 137 for the traction battery shown in FIG. 2. Each component that is shown in FIG. 2 is also shown in FIG. 5 and the components of FIG. 5 operate as is described in the description of FIG. 2. However, in FIG. 5, switch S1 is shown in a closed state while switches S2 and S3 are in an open state. This configuration suspends or prevents electric current flow through the first group 204 of battery cells 137 while still allowing electric current flow through the first group 204 of battery cells 137. Additionally, this arrangement causes the voltage that may be available at the DC bus to follow the voltage that is across the first group 204 of battery cells 137. Thus, the DC bus voltage may be reduced by one half if degradation of the first group 204 of battery cells 137 is detected. The DC bus voltage may be made available to electric machine 126 (e.g., a traction motor that provides propulsive effort for the vehicle), DC/DC converter 189, inverter 260, and pump 252. Accordingly, DC/DC converter 189, inverter 260, and pump 252 remain operational in this configuration when degradation is sensed within the second group 206 of battery cells. Thus, closing S1 and opening S2 and S3 deactivates the second group 206 and activates the first group 204 of battery cells 137 by allowing the first group 204 of battery cells to receive charge from the vehicle’s DC bus or supply charge to the vehicle’s DC bus. The second group of battery cells 206 is deactivated since the second group 206 of battery cells 137 is not permitted to receive charge from or provide charge to the vehicle’s DC bus.

Referring now to FIG. 6, a method for operating a battery pack is shown. At least portions of method 600 may be included as executable instructions stored in non-transitory memory of one or more controllers. Further, some portions of method 600 may be actions performed in the physical world via the one or more controllers and one or more actuators. Method 600 may be included in the systems of FIGS. 1 and 2.

At 602, method 600 determines traction battery operating conditions. Traction battery operating conditions may include but are not limited to pressures within battery pack cells, battery pack voltages, and battery pack temperatures. Method 600 proceeds to 604.

At 604, method 600 judges whether or not there is an indication of an unexpected traction battery thermal condition or thermal degradation. An unexpected traction battery thermal condition may be indicative of degradation within a group of battery cells in the traction battery. Each group of battery pack cells is monitored for battery voltage, battery cell voltage, pressure of cooling fluid within the battery, and battery temperature. Further, coolant pump speed and the amount of power being consumed by the coolant pump are monitored for an indication of an unexpected traction battery thermal condition. For example, if a battery cell pressure or pressure of coolant in a battery increases at a rate that is above a threshold rate, or if battery cell temperature rate of increase exceeds a threshold rate, or if battery temperature exceeds a predetermined temperature, method 600 may judge that there is an unexpected traction battery thermal condition. The pressure and/or temperature increases may be indicative of thermal degradation within a battery pack. In addition, if method 600 judges that coolant pump speed decreases at greater than a threshold rate and/or if electric power consumed by the coolant pump increases at a rate that is greater than a threshold rate, method 600 may judge that there is an unexpected traction battery thermal condition. The coolant pump speed decrease and coolant pump electric power consumption increase may result from increase pressure in battery cells where temperature is increasing. If method 600 judges that there is an indication of thermal degradation within a battery pack or battery cell, the answer is yes and method 600 proceeds to 606. Otherwise, the answer is no and method 600 proceeds to 620.

At 606, method 600 opens one or more switches of a switch module or group to electrically deactivate one or more battery cell groups (e.g., prevent current flow through the battery cell group) that are determined to be affected by the detected battery cell or battery pack thermal degradation. For example, if thermal degradation is indicated in first group 204 of battery cells 137, switches S1 and S3 are opened as shown in FIG. 4 to prevent and suspend electric current flow through the first group 204 of battery cells 137. Conversely, if thermal degradation is indicated in second group 206 of battery cells 137, switches S2 and S3 are opened as shown in FIG. 5 to prevent and suspend electric current flow through the second group 206 of battery cells 137. Method 600 proceeds to 608.

At 608, method 600 closes one or more switches of a switch module or group to electrically activate or keep activated one or more battery cell groups that are determined to be unaffected by the detected battery cell or battery pack thermal degradation. For example, if thermal degradation is indicated in first group 204 of battery cells 137, switch S2 is closed as shown in FIG. 4 to allows electric current flow through the second group 206 of battery cells 137. Conversely, if thermal degradation is indicated in second group 206 of battery cells 137, switch S1 is closed as shown in FIG. 5 to allow electric current flow through the first group 204 of battery cells 137. Method 600 proceeds to 610.

At 610, method 600 optionally adjusts coolant pump flow in response to the indication of the unexpected traction battery thermal condition. In one example, a rotational speed of the coolant pump may be increased in response to the indication of the unexpected traction battery thermal condition. This action may allow the affected battery group to be maintained within a desirable temperature range by increasing coolant that is supplied to the affected battery cells. Method 600 proceeds to 612.

At 612, method 600 adjusts flow of coolant to the group of battery cells that have been affected by the unexpected traction battery thermal condition. Method 600 may adjust a position of a valve that supplies cooling fluid to the group of battery cells that have been affected by the unexpected traction battery thermal condition. For example, method 600 may open further a valve that controls flow of the fluid to the affected group of battery cells so that flow of the fluid to the affected group of battery cells increases in response to the indication of the unexpected thermal event. Additionally, method 600 may adjust a position of a valve that controls flow of fluid to the unaffected group of battery cells so that flow of fluid to the unaffected group of battery cells may be maintained. Method 600 proceeds to exit.

At 620, method 600 operates one or more switches of a switch module or group to permit different battery cell groups to be charged or discharged at a same time or individual battery cell groups to be charged or discharged as requested (e.g., activating the battery cell groups). For example, to enable charging and discharging of first and second groups of battery cells at a same time, method 600 closes switch S3 and opens switches S1 and S2 as shown in FIG. 3. This configuration may be requested when the two battery cell groups are operating as may be expected or desired. However, if the first group 204 of battery cells 137 are to be charged without charging the second group 206 of battery cells 137, then method 600 may close switch S1 and open switches S2 and S3 so that the first group 204 of battery cells 137 is the sole group of battery cells to be charged.

Method 600 may also operate the one or more switches of the switch module or group according to a requested voltage for the vehicle’s high voltage DC bus. For example, to generate a maximum torque via the vehicle’s traction motor, method 600 may close switch S3 and open switches S1 and S2 as shown in FIG. 3. This allows a maximum traction battery voltage to be applied to the vehicle’s DC bus. In one or more reduced capacity operating modes, method 600 may apply less than a maximum traction battery voltage to the vehicle’s DC bus. For example, if the vehicle wishes to apply a voltage generated solely by the second group 206 of battery cells 137 to the vehicle’s DC bus when a temperature of the first group 204 of battery cells 137 is above a threshold temperature, method 600 may close switch S2 and open switches S1 and S3. Method 600 considers both the requested DC bus voltage and requested charging and discharging of battery cells to determine which switches of the switch module are to be open or closed. Method 600 proceeds to exit.

The method of FIG. 6 provides for a method for controlling a battery pack, comprising: via one or more controllers, electrically deactivating a first group of fluid immersed battery cells of the battery pack and electrically activing a second group of fluid immersed battery cells of the battery pack in response to an indication of thermal degradation of the first group of fluid immersed battery cells. In a first example, the method includes where the first group of fluid immersed battery cells of the battery pack are electrically deactivated via a switching module, and where the second group of fluid immersed battery cells of the battery pack are electrically activated via the switching module. In a second example that may include the first example, the method includes where the thermal degradation is based on a pressure within the first group of fluid immersed battery cells, where deactivating the first group of fluid immersed battery cells includes preventing electric current flow from or to the first group of fluid immersed battery cells, and where activing a second group of fluid immersed battery cells of the battery pack includes permitting electric current flow from or to the second group of fluid immersed battery cells. In a third example that may include one or both of the first and second examples, the method includes where the thermal degradation is based on a speed of a pump and an amount of electric power flowing to the pump. In a fourth example that may include one or more of the first through third examples, the method includes where the pump supplies a fluid to the first group of fluid immersed battery cells. In a fifth example that may include one or more of the first through fourth examples, the method further comprises supplying electric power to a pump that supplies a fluid to the first group of fluid immersed battery cells via the second group of fluid immersed battery cells while the indication of thermal degradation is present. In a sixth example that may include one or more of the first through fifth examples, the method further comprises adjusting a speed of the pump in response to the indication of thermal degradation of the first group of fluid immersed battery cells.

The method of FIG. 6 also provides for a method for controlling a battery pack, comprising: via one or more controllers, electrically deactivating a first group of fluid immersed battery cells of the battery pack, electrically activating a second group of fluid immersed battery cells of the battery pack in response to an indication of thermal degradation of the first group of fluid immersed battery cells, adjusting flow of a fluid to the first group of fluid immersed battery cells, and adjusting flow of the fluid to the second group of fluid immersed battery cells in response to an indication of thermal degradation of the first group of fluid immersed battery cells. In a first example, the method further comprises adjusting flow through a pump supplying the fluid to the first group of fluid immersed battery cells and the second group of fluid immersed battery cells. In a second example that may include the first example, the method includes where adjusting flow through the pump includes increasing flow through the pump. In a third example that may include one or both of the first and second examples, the method includes where adjusting flow through the first group of fluid immersed battery cells of the battery pack includes increasing flow through the first group of fluid immersed battery cells. In a fourth example that may include one or more of the first through third examples, the method includes where adjusting flow through the second group of fluid immersed battery cells of the battery pack includes maintaining flow through the second group of fluid immersed battery cells.

Turning now to FIG. 7, an example of a prophetic traction battery operating sequence is shown. The operating sequence of FIG. 7 may be performed via the system of FIG. 1-5 and the method of FIG. 6. The vertical lines at time t0 and t1 represents times of interest during the operating sequence.

The first plot from the top of FIG. 7 is a plot of an operating status of a first group of traction battery cells versus time. The vertical axis represents the operating status of the first group of traction battery cells. The horizontal axis represents time and time increases from the left side of the plot to the right side of the plot. Trace 702 represents the operating status of the first group of traction battery cells. The first group of traction battery cells are active (e.g., the battery cells may receive or supply electric current) when trace 702 is at a higher level near the vertical axis arrow. The first group of traction battery cells are deactivated (e.g., the battery cells may not receive or supply electric current) when trace 702 is at a lower level near the horizontal axis.

The second plot from the top of FIG. 7 is a plot of an operating status of a second group of traction battery cells versus time. The vertical axis represents the operating status of the second group of traction battery cells. The horizontal axis represents time and time increases from the left side of the plot to the right side of the plot. Trace 704 represents the operating status of the second group of traction battery cells. The second group of traction battery cells are active (e.g., the battery cells may receive or supply electric current) when trace 704 is at a higher level near the vertical axis arrow. The second group of traction battery cells are deactivated (e.g., the battery cells may not receive or supply electric current) when trace 704 is at a lower level near the horizontal axis.

The third plot from the top of FIG. 7 is a plot of pressure within a first group of traction battery cells versus time. The vertical axis represents the pressure in the first group of traction battery cells. The horizontal axis represents time and time increases from the left side of the plot to the right side of the plot. Trace 706 represents the pressure in the first group of traction battery cells. The pressure in the first group of traction battery cells increases in the direction of the vertical axis arrow. Dashed line 750 represents a threshold level that when exceeded by trace 706 provides an indication of thermal degradation within the first group of traction battery cells.

The fourth plot from the top of FIG. 7 is a plot of pressure within a second group of traction battery cells versus time. The vertical axis represents the pressure in the second group of traction battery cells. The horizontal axis represents time and time increases from the left side of the plot to the right side of the plot. Trace 708 represents the pressure in the second group of traction battery cells. The pressure in the second group of traction battery cells increases in the direction of the vertical axis arrow. Dashed line 752 represents a threshold level that when exceeded by trace 708 provides an indication of thermal degradation within the first group of traction battery cells.

The fifth plot from the top of FIG. 7 is a plot of coolant flow to a first group of traction battery cells versus time. The vertical axis represents the coolant flow to the first group of traction battery cells. The horizontal axis represents time and time increases from the left side of the plot to the right side of the plot. Trace 710 represents the coolant flow to the first group of traction battery cells. The coolant flow rate to the first group of traction battery cells increases in the direction of the vertical axis arrow.

The fourth plot from the top of FIG. 7 is a plot of coolant flow to a second group of traction battery cells versus time. The vertical axis represents the coolant flow to the second group of traction battery cells. The horizontal axis represents time and time increases from the left side of the plot to the right side of the plot. Trace 712 represents the coolant flow to the second group of traction battery cells. The coolant flow rate to the second group of traction battery cells increases in the direction of the vertical axis arrow.

At time t0, the first and second groups of battery cells are activated and pressures within the first and second battery cell groups is lower than thresholds 750 and 752. The coolant flow rate through the two groups of battery cells is at a middle level.

At time t1, the first group of battery cells is deactivated via a switch (not shown) while the second group of battery cells remains activated. The first group of battery cells are deactivated in response to pressure in the first group of battery cells exceeding threshold 750. The flow rate of coolant to the second group of battery cells is increased since the second group of battery cells is the sole group of battery cells now providing electric power to vehicle power consumers. This may increase cooling of the second group of battery cells, which may be desirable with an increase in load on the second group of battery cells. The flow rate of coolant to the first group of battery cells is maintained. These actions reduce temperature within the first group of battery cells and maintain the temperature of the second group of battery cells.

The methods and routines disclosed herein may be stored as executable instructions in non-transitory memory and may be carried out by a system including the controller in combination with the various sensors and actuators. Further, portions of the methods may be physical actions taken in the real world to change a state of a device. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the examples described herein, but is provided for ease of illustration and description. One or more of the illustrated actions, operations and/or functions may be repeatedly performed depending on the particular strategy being used. Further, the described actions, operations and/or functions may graphically represent code to be programmed into non-transitory memory of the computer readable storage medium in the system, where the described actions are carried out by executing the instructions in a system including the various hardware components in combination with the electronic controller. One or more of the method steps described herein may be omitted if desired.

While various embodiments have been described above, it may be understood that they have been presented by way of example, and not limitation nor restriction. It will be appreciated that the configurations and routines disclosed herein are exemplary in nature, and that these specific examples are not to be considered in a limiting sense, because numerous variations are possible. For example, the above technology can be applied to powertrains that include different types of propulsion sources including different types of electric machines, internal combustion engines, and/or transmissions. The technology may be used as a stand-alone, or used in combination with other power transmission systems not limited to machinery and propulsion systems for tandem axles, electric tag axles, P4 axles, HEVs, BEVs, agriculture, marine, motorcycle, recreational vehicles and on and off highway vehicles, as an example. The subject matter of the present disclosure includes all novel and non-obvious combinations and sub-combinations of the various systems and configurations, and other features, functions, and/or properties disclosed herein. It will be apparent to persons skilled in the relevant arts that the disclosed subject matter may be embodied in other specific forms without departing from the spirit of the subject matter.

The following claims particularly point out certain combinations and sub-combinations regarded as novel and non-obvious. These claims may refer to “an” element or “a first” element or the equivalent thereof. Such claims may be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure. As used herein, the term “approximately” is construed to mean plus or minus five percent of the range, unless otherwise specified.

1. A method for controlling a battery pack, comprising:
via one or more controllers, electrically deactivating a first group of fluid immersed battery cells of the battery pack and electrically activing a second group of fluid immersed battery cells of the battery pack in response to an indication of thermal degradation of the first group of fluid immersed battery cells.

2. The method of claim 1, where the first group of fluid immersed battery cells of the battery pack are electrically deactivated via a switching module, and where the second group of fluid immersed battery cells of the battery pack are electrically activated via the switching module.

3. The method of claim 1, where the thermal degradation is based on a pressure within the first group of fluid immersed battery cells, where deactivating the first group of fluid immersed battery cells includes preventing electric current flow from or to the first group of fluid immersed battery cells, and where activing the second group of fluid immersed battery cells of the battery pack includes permitting electric current flow from or to the second group of fluid immersed battery cells.

4. The method of claim 1, where the thermal degradation is based on a speed of a pump and an amount of electric power flowing to the pump.

5. The method of claim 4, where the pump supplies a fluid to the first group of fluid immersed battery cells.

6. The method of claim 1, further comprising supplying electric power to a pump that supplies a fluid to the first group of fluid immersed battery cells via the second group of fluid immersed battery cells while the indication of thermal degradation is present.

7. The method of claim 6, further comprising adjusting a speed of the pump in response to the indication of thermal degradation of the first group of fluid immersed battery cells.

8. A battery pack system, comprising:
a traction battery including a first group of battery cells immersed in a fluid and a second group of battery cells immersed in the fluid; and
one or more controllers including executable instructions stored in controller memory that cause the one or more controllers to electrically deactivate the first group of battery cells or the second group of battery cells from a high voltage bus while electrically activating the other of the first group of battery cells or the second group of battery cells to the high voltage bus.

9. The battery pack system of claim 8, where the high voltage bus is electrically coupled to a traction motor.

10. The battery pack system of claim 9, where the high voltage bus is electrically coupled to a DC/DC converter, and where the DC/DC converter is electrically coupled to a pump.

11. The battery pack system of claim 8, further comprising a battery cooling system including a heat exchanger, a pump, and one or more valves, the battery cooling system fluidically coupled to the traction battery.

12. The battery pack system of claim 11, further comprising additional executable instructions that cause the one or more controllers to control flow of the fluid to the first group of battery cells immersed in the fluid and the second group of battery cells immersed in the fluid.

13. The battery pack system of claim 12, where flow of the fluid is controlled via adjusting a rotational speed of the pump.

14. The battery pack system of claim 12, where flow of the fluid is controlled via adjusting positions of the one or more valves.

15. The battery pack system of claim 8, further comprising a switching module and where the first group of battery cells or the second group of battery cells is electrically isolated via the switching module.

16. A method for controlling a battery pack, comprising:
via one or more controllers, electrically deactivating a first group of fluid immersed battery cells of the battery pack, electrically activating a second group of fluid immersed battery cells of the battery pack in response to an indication of thermal degradation of the first group of fluid immersed battery cells, adjusting flow of a fluid to the first group of fluid immersed battery cells, and adjusting flow of the fluid to the second group of fluid immersed battery cells in response to the indication of thermal degradation of the first group of fluid immersed battery cells.

17. The method of claim 16, further comprising adjusting flow through a pump supplying the fluid to the first group of fluid immersed battery cells and the second group of fluid immersed battery cells.

18. The method of claim 17, where adjusting flow through the pump includes increasing flow through the pump.

19. The method of claim 16, where adjusting flow through the first group of fluid immersed battery cells of the battery pack includes increasing flow through the first group of fluid immersed battery cells.

20. The method of claim 16, where adjusting flow through the second group of fluid immersed battery cells of the battery pack includes maintaining flow through the second group of fluid immersed battery cells.
